(19) United States
(12) Patent Application Publication
(10) Pub. No.: US 2019/0156305 A1
(43) Pub. Date: May 23, 2019

(54) ELECTRONIC TRANSACTION ANALYSIS AND MATCHING IN A NETWORK

(71) Applicant: Onyx CenterSource, Inc., Dallas, TX (US)

(72) Inventors: Mark S. Dubrow, Dallas, TX (US); Joseph W. Nicholson, Fairview, TX (US)

(21) Appl. No.: 15/820,021

(22) Filed: Nov. 21, 2017

(51) Int. Cl. G06Q 20/08; G06Q 10/02

(52) U.S. Cl. CPC G06Q 20/08; G06Q 10/02

(57) ABSTRACT

A system for reconciling a group of electronic transactions comprising a memory configured to store transaction information associated with a group of scheduled electronic transactions. The transaction information includes an end time for the group of scheduled transactions. The memory also stores transaction information associated with executed electronic transactions. The system further comprises a first interface configured to receive, from a first user, information associated with the group of scheduled transactions; and a second interface configured to receive, from a second user, information associated with the executed transactions. The system further comprises a processor communicably coupled to the memory, the first interface, and the second interface. The processor determines that the end time for the group of scheduled transactions has passed; compares the executed transactions with the group of scheduled transactions to determine a set of fulfilled transactions; and generates a request for payment fulfillment for the fulfilled transactions.

### TECHNICAL FIELD

The present disclosure relates generally to analyzing scheduled and executed electronic transactions in a network, and more specifically to matching an executed electronic transaction with a scheduled group of electronic transactions.

### BACKGROUND

Accurately matching electronic transactions scheduled in one network with electronic transactions executed in another network poses several technical challenges. For example, a group of electronic transactions may be scheduled using a first network. The group of electronic transactions are to be executed in a second network. One or more of the scheduled electronic transactions may or may not actually be executed in the second network. Other events in the first network may depend on whether the electronic transaction was actually executed in the second network. Thus, the first network may not know whether to perform the other events. The first network may have to trust that the electronic transaction was executed in the second network. This may lead to a mismatch between what the first network expects and what was actually executed.

For example, a user (or operator) of the first network may schedule a group of electronic transactions to be executed in a second network. A user (or operator) of the second network may receive income for each executed electronic transaction. The second network user may owe the first network user a percentage of each transaction. The first network user does not know whether it receives the correct percentage without knowledge of which scheduled electronic transactions were actually completed in the second network.

For reasons of network security, data security, and data privacy, however, neither the first user nor the second user provides the other with access to its network or data. Thus, conventional networks include several technical challenges for reconciling electronic transactions scheduled in one network with electronic transactions executed in another network.

### SUMMARY

According to some embodiments, a system for reconciling a group of electronic transactions comprises a memory configured to store transaction information associated with a group of scheduled electronic transactions (e.g., electronic hotel reservations for a group meeting or event). The transaction information includes an end time for the group of scheduled electronic transactions (e.g., an end date for the meeting or event). The memory is also configured to store transaction information associated with executed electronic transactions (e.g., electronic hotel transactions for completed stays at the hotel).

The system further comprises a first interface configured to receive, from a first user, information associated with the group of scheduled electronic transactions. For example, the first user may comprise a travel agent or event planner.

The system further comprises a second interface configured to receive, from a second user, information associated with the executed electronic transactions. For example, the second user may comprise a hotel user.

The system further comprises a processor communicably coupled to the memory, the first interface, and the second interface. The processor is configured to: deteimine the end time for the group of scheduled electronic transactions has passed (e.g., the event or meeting is over); compare the information associated with the executed electronic transactions with the information associated with the group of scheduled electronic transactions to determine a set of fulfilled electronic transactions (e.g., reconcile the reservations with the completed hotel stays); and generate a request for payment fulfillment for the set of fulfilled electronic transactions (e.g., funding or remittance notice for agent or event planner commission payment).

The second interface is further configured to receive, from the second user, an approval of the request for payment fulfillment for the set of fulfilled electronic transactions. The processor is further configured to transfer funds from an account associated with the second user to an account associated with the first user (e.g., automatic payment from hotel account to agent account).

In particular embodiments, the first interface comprises a bulk transfer interface with an event management system (e.g., file transfer or other interface for importing event information in bulk from a third party event management system). The second interface may comprise a bulk transfer interface with a hotel property management system (e.g., file transfer or other interface for importing completed stay information from a hotel's reservation or property management system, either on demand or at a scheduled interval).

In particular embodiments, at least one of the first interface or the second interface is configured to receive contract information associated with the group of scheduled electronic transactions. For example, the agent, the hotel, or both may upload contract information for the meeting or event.

In particular embodiments, the transaction information associated with the group of scheduled electronic transactions comprises: an event name; an event start date; an event end date; hotel property information; travel agent or event planner information; and a list of event attendees.

In particular embodiments, the processor is further configured to translate the received information associated with the group of scheduled electronic transactions into an internal format. For example, the processor may receive transaction information from different third party event management systems in different formats. The processor may translate each format into a common internal format.

Similarly, the processor may translate the received information associated with the executed electronic transactions into an internal format. For example, the processor may receive transaction information from different hotel or property management systems in different formats. The processor may translate each foiinat into a common internal format.

In particular embodiments, the first interface is further configured to receive account information for receiving the transfer of funds. The second interface may be configured to receive account information for sending the transfer of funds.

According to some embodiments, a method of reconciling a group of electronic transactions comprises receiving, over a first interface from a first user, transaction information associated with a group of scheduled electronic transactions. The transaction information includes an end time for the group of scheduled electronic transactions. The method further comprises receiving, over a second interface from a second user, transaction information associated with executed electronic transactions; determining the end time for the group of scheduled electronic transactions has passed; comparing the information associated with the executed electronic transactions with the information associated with the group of scheduled electronic transactions to determine a set of fulfilled electronic transactions; generating a request for payment fulfillment for the set of fulfilled electronic transactions; receiving, from the second user, an approval of the request for payment fulfillment for the set of fulfilled electronic transactions; and transferring funds from an account associated with the second user to an account associated with the first user.

In particular embodiments, the first user comprises a travel agent or event planner user; the second user comprises a hotel user; the group of scheduled electronic transactions comprises a group hotel reservation; the executed electronic transactions comprise completed hotel stay transactions; and the generated request for payment fulfillment comprises an remittance notice for a commission payment to the first user for the set of fulfilled electronic transactions.

In particular embodiments, the first interface comprises a bulk transfer interface with an event management system. The second interface may comprise a bulk transfer interface with a hotel property management system.

In particular embodiments, the method further comprises, receiving, on at least one of the first interface or the second interface, contract information associated with the group of scheduled electronic transactions.

In particular embodiments, the transaction information associated with the group of scheduled electronic transactions comprises: an event name; an event start date; an event end date; hotel property information; travel agent or event planner information; and a list of event attendees.

In particular embodiments, the method further comprises translating the received information associated with the group of scheduled electronic transactions into an internal format. The method may also comprise translating the received information associated with the executed electronic transactions into an internal format.

In particular embodiments, the method further comprises receiving, on the first interface, account information for receiving the transfer of funds. The method may comprise receiving, on the second interface, account information for sending the transfer of funds.

The embodiments described herein present several technical advantages. In one embodiment, the system translates data from various event management and/or hotel management systems into a common format so that data comparison and analysis is simplified. The analysis is more efficient when performed on a single format instead of duplicating the logic for each third party format.

Some embodiments improve network and data security. For example, neither user needs access to the other user's network because the electronic transaction information is stored and analyzed by a trusted third party. Any disputes may be resolved by the third party. In addition to improved security and privacy, particular embodiments are more efficient and consume less network resources because the number of disputes may be reduced, and any disputes may be handled by the trusted third party.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of networks that include electronic transactions;

FIG. 2 is a block diagram of a system for reconciling a group of electronic transactions, according to some embodiments;

FIG. 3 is a flowchart illustrating an example method of reconciling a group of electronic transactions, according to some embodiments; and

FIGS. 4-7 illustrate examples of graphical user interfaces, according to particular embodiments.

### DETAILED DESCRIPTION

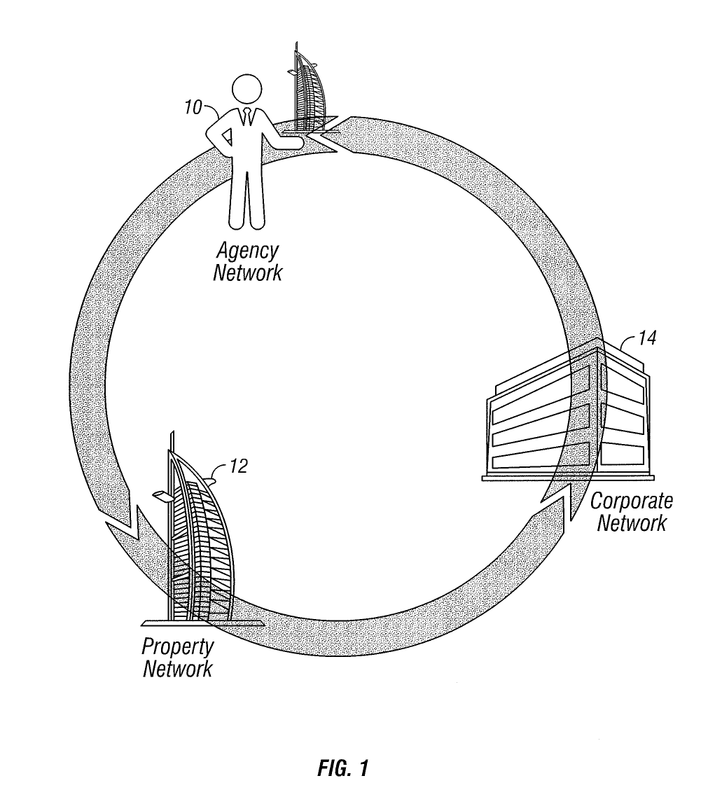

Accurately matching electronic transactions scheduled in one network with electronic transactions executed in another network poses several technical challenges. One example may include systems used in the event planning and hospitality industries. An example is illustrated in FIG. 1.

FIG. 1 is an example of networks that include electronic transactions. The various networks include agency network 10, property network 12, and corporate network 14.

Agency network 10 includes a network or networks used by a travel agent, meeting planner, event planner, etc., for scheduling a group of electronic transactions. The scheduled group of electronic transactions may comprise hotel reservations for the attendees of a group event. Network 10 may include computer systems such as event management systems for finding and locating an event property, requesting bids from potential event hosts, registering event attendees, etc., and/or contact management systems for maintaining property and/or attendee contact information.

Property network 12 includes a network or networks used by a particular facility for property and/or reservation management. In the illustrated embodiment, the facility comprises a hotel. For example, the hotel may host one or more group events or meetings. Property network 12 may include a hotel property management system that manages guest check-in/check-out, room access, conference room reservations, catering, etc. Property network 12 may also include a reservation management system that maintains guest reservations.

Each guest stay is associated with an electronic transaction (e.g., the electronic record of a guest's check-in/check-out dates, room rate, miscellaneous charges, etc.). For reasons described in more detail below, it is beneficial to both the agency and the property if scheduled electronic transactions in agency network 10 may be matched with the electronic transactions in property network 12.

Corporate network 14 includes a network or networks for providing back end support for one or more associated properties. For example, the associated properties may include hotels in the same hotel chain. Back end support may include accounting, human resources, purchasing, etc. Corporate network 14 may also include corporate sales. A meeting planner may book an event directly with a hotel property, or through the hotel chain's corporate sales.

Particular examples and embodiments may be described with respect to a meeting planner, but the term meeting planner may refer to any event planner, travel agent, representative thereof, etc. who plans group events (e.g., non-transient events, or events with more than 9 people or room reservations). Similarly, the term hotel as used herein may refer to a motel, inn, guest house, convention center, lodge, or any other short term rental accommodations suitable for hosting a group event.

Reconciling electronic transactions between agency network 10, property network 12, and corporate network 14 includes several technical problems. For example, a meeting planner may be entitled to a commission for the group event from the hotel based on the number of event attendees that completed stays at the hotel.

The meeting planner may know which event attendees registered for the event, but the meeting planner may not know whether the attendees actually completed a stay at the hotel. For example, some registered attendees may change their mind and cancel at the last minute, or simply not show up. Some registered attendees may check-in later or leave earlier than anticipated.

When attendee reservations are made through agency network 10, the meeting planner may have a good idea of who attended and for how long. Some attendees, however, may make reservations directly through the hotel, or may change an earlier made reservation once at the hotel property (e.g., room upgrade, check-out a day earlier or day later, etc.). The hotel may not know whether the attendee is associated with a particular event. The hotel may misclassify a guest as transient business instead of group business.

Thus, a problem is that the meeting planner may not accurately know how much commission is due because the meeting planner does not have visibility into property network 12. The meeting planner has to trust that the hotel accurately associated all executed electronic transactions (e.g., hotel stay records) with the group of scheduled electronic transactions (e.g., event attendee registration records).

A problem for the hotel property, as described above, is that matching a room to an event can be challenging, particularly when guests check-in/check-out on different days. The hotel may not be able to associate a commission payment with a particular event or group simply because the hotel lacks the information to do so.

For some events, a meeting planner may book an event directly with a hotel property. For some events, a meeting planner may book an event with a hotel chain's corporate sales department. The hotel chain may not have visibility into the determination of commission payment at a particular hotel property. A problem is that neither the hotel chain nor the hotel property have a holistic view of the group event. For example, a contract specifying the dates, number of rooms, commission percentage, etc., may be stored on corporate network 14, but not on property network 12, or vice versa.

Particular embodiments obviate the problems described above and include a system and method for reconciling electronic transactions. Particular embodiments include automated and transparent ways to communicate, share event details, and improve the speed of payments, which may result in increased room fulfillment, a faster pay cycle, and a more trusted business relationship between meeting planners and hotels. Particular embodiments provide improved data security and privacy over other potential solutions.

Event planning solution providers offer tools focused on venue availability and selection. The tools may also provide event attendee registration solutions. The embodiments described herein bridge the gap so that hotels and agents can quickly access contract information, review reservations made by attendees, and view status updates of payment processes. Particular embodiments automate the tasks that enable commission payment reconciliation of group stays. Easy access to event details and immediate availability of activity status provide transparency to the agency, property, and corporate sales.

Particular embodiments require minimal information for creating an event. For example, integration to customer relationship management (CRM) systems automatically updates an event with relevant data such as event contact information, group RSVPs, hotel reservations, completed hotel stay status, etc. Particular embodiments may create events by automatically grouping hotel reservations. Contract details may be added to an automatically generated event at any time.

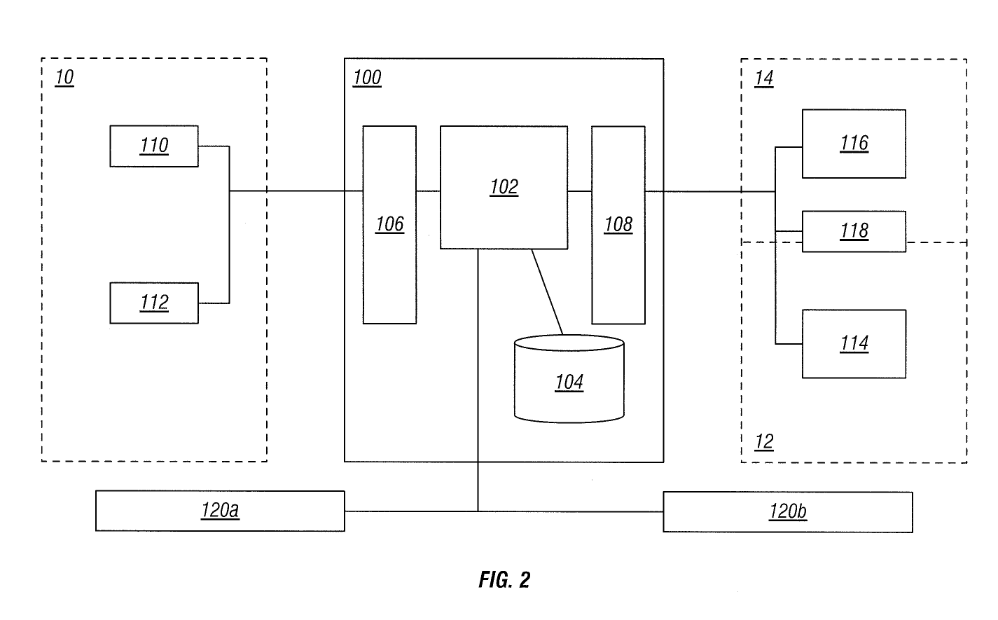

Particular embodiments and their advantages are best understood by reference to FIGS. 2 through 7, wherein like reference numbers indicate like features. An example system for reconciling a group of electronic transactions is illustrated in FIG. 2.

FIG. 2 is a block diagram of a system for reconciling a group of electronic transactions, according to some embodiments. System 100 includes processor 102 communicably coupled to memory 104, interface 106, and interface 108. In some embodiments, system 100 may be referred to as a cloud system.

Processor 102 may be implemented as one or more central processing unit (CPU) chips, logic units, cores (e.g., a multi-core processor), field-programmable gate arrays (FPGAs), application specific integrated circuits (ASICs), or digital signal processors (DSPs). Processor 102 may include hardware and software.

Memory 104 comprises one or more disks, tape drives, or solid-state drives, and may be used as an over-flow data storage device, to store programs when such programs are selected for execution, and to store instructions and data that are read during program execution. The memory may be volatile or non-volatile and may comprise read-only memory (ROM), random-access memory (RAM), ternary content-addressable memory (TCAM), dynamic random-access memory (DRAM), and static random-access memory (SRAM).

Processor 102 may send and receive information via interfaces 106 and 108. In some embodiments, interfaces 106 and 108 comprise network interfaces. Interfaces 106 and 108 may be configured for wired and/or wireless communications and to communicate data through a network, system, and/or domain. For example, interfaces 106 and 108 may be configured for communication with a modem, a switch, a router, a bridge, a server, or a client. A network may comprise any suitable type of wireless and/or wired network including, but not limited to, all or a portion of the Internet, the public switched telephone network, a cellular network, and/or a satellite network.

Interfaces 106 and 108 may include hardware and software. Interfaces 106 and 108 may be configured to support any suitable communication protocols as would be appreciated by one of ordinary skill in the art upon viewing this disclosure.

For example, in some embodiments interfaces 106 and 108 may comprise a graphical user interface, such as a web-based interface, for interaction with a user. In some embodiments, interfaces 106 and 108 may comprise a bulk transfer interface, such as a file transfer interface, for importing or exporting large amounts of information with little or no user interaction (e.g., export/import to other management systems such as event management systems or property management systems). Interfaces 106 and 108 are illustrated as two separate interfaces for ease of explanation, but in some embodiments interfaces 106 and 108 may comprise a single interface.

In some embodiments, interface 106 may transmit and receive information with an agent network, such as agent network 10. Agent network 10 may include user terminal 112. A meeting planner may interact with system 100 via interface 106 using user terminal 112. Agent network 10 may include management system 110, such as a contact management system, customer relationship management system, contract management system, and/or an event management system. Management system 110 may interact with system 100 via interface 106 (e.g., to complete a bulk transfer).

In some embodiments, interface 108 may transmit and receive information with a hotel network, such as property network 12 and/or corporate network 14. Networks 12 and 14 may include user terminals 114 and 116, respectively. A hotel employee or representative (hotel user) may interact with system 100 via interface 108 using user terminals 114 and/or 116. Networks 12 and 14 may include management system 118, such as a reservation management system, property management system, or any other facility management system. Management system 118 may interact with system 100 via interface 108 (e.g., to complete a bulk transfer).

In some embodiments, interface 106 is configured to receive, from a user of agent network 10 (e.g., a meeting planner), information associated with a group of scheduled electronic transactions (e.g., group event information, such as an event name, an event start date, an event end date, hotel property information, travel agent or event planner information, a list of event attendees, etc.). The transaction information includes an end time for the group of scheduled electronic transactions (e.g., the event end date).

In some embodiments, interface 108 is configured to receive, from a user of networks 12 or 14, information associated with executed electronic transactions (e.g., completed hotel stays). Interface 108 may receive the information associated with executed electronic transactions via a bulk interface (e.g., file download, etc.) on demand, or according to a periodic schedule (e.g., daily, weekly, monthly, etc.).

Processor 102 may store the electronic transaction information received via interfaces 106 and 108 in memory 104. In some embodiments, processor 102 may translate the electronic transaction information received via interfaces 106 and 108 into an internal format for storing in memory 104.

For example, interfaces 106 and/or 108 may communicate with various management systems of agent network 10, property network 12, or corporate network 14 (e.g., systems from various third party vendors). Various management systems may format the electronic transaction information differently. Processor 102 may translate the different formats into a common format for storage in memory 104.

In some embodiments, processor 102 may be operable to identify particular headers in the electronic transaction information and convert the data associated with the particular header to an equivalent value in the common format. In some embodiments, interfaces 106 and/or 108 may receive electronic transaction information as a comma delimited file, or any other suitable file format.

Processor 102 reconciles the transaction information associated with the group of scheduled electronic transactions (e.g., group event attendee information) with the transaction information associated with executed electronic transactions (e.g., the completed hotel stays). In some embodiments, processor 102 determines the end time for the group of scheduled electronic transactions has passed. For example, processor 102 stores the end date for the group event. Processor 102 may determine the group event is over, and reconcile the transactions soon thereafter, or processor 102 may reconcile all group events for a particular time period (e.g., week, month, etc.) at the end of the time period.

Processor 102 compares the information associated with the executed electronic transactions with the information associated with the group of scheduled electronic transactions to determine a set of fulfilled electronic transactions (e.g., completed hotel stay associated with the group event). For example, processor 102 compares the completed hotel stays with the group event registration information to determine which event attendees actually completed a stay at the hotel, for how long, at what nightly rate, etc.

Processor 102 uses the comparison information to generate a request for payment fulfillment for the set of fulfilled electronic transactions. In some embodiments, processor 102 may send the request for payment fulfillment via interface 108 to the hotel property or hotel chain for approval. If processor 102 receives approval for the request for payment fulfillment, processor 102 may make a commission payment to the meeting planner. The request for payment fulfillment may also be referred to as a funding notice or remittance notice.

In some embodiments, the commission payment may be automated. For example, the meeting planner may have an account at financial institution 120a and the hotel property or hotel chain may have an account at financial institution 120b. Processor 102 may initiate a funds transfer from financial institution 120b to financial institution 120a for the commission payment.

In particular embodiments, the meeting planner and/or the hotel may send financial account information to system 100. In addition to account numbers, the configuration information may include a preferred currency, or any other suitable account information.

In some embodiments, interfaces 106 and/or 108 may receive contract information. For example, a group event may include a contract between the meeting planner and the hotel. In particular embodiments, contract documents can be uploaded and stored in memory 104 (e.g., as a PDF or Image file). The contract information may be associated with the group event. In some embodiments, processor 102 may parse the contract document to extract common information to store in a common format.

In particular embodiments, the contract documents can be viewed by users that have validated access to the group event, such as, a hotel chain and brand manager, hotel property representative, agency representative, etc.

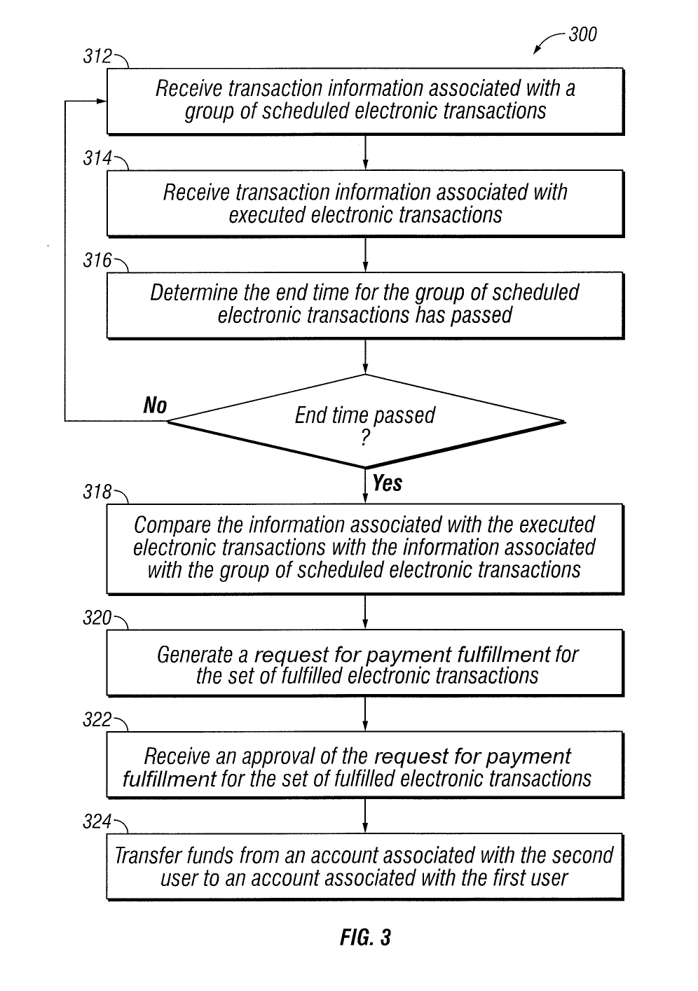

FIG. 3 is a flowchart illustrating an example method of reconciling a group of electronic transactions, according to some embodiments. Method 300 may be performed by the components described with respect to FIGS. 1 and 2.

The method begins at step 312, where the system receives, over a first interface from a first user, transaction information associated with a group of scheduled electronic transactions. For example, processor 102 may receive via interface 106 transaction information associated with a group event (e.g., event information, attendee information, etc.) from agency network 10 (e.g., a meeting planner (or representative)). In some embodiments, the user may comprise a management system such as a contact or event management system.

The transaction information includes an end time for the group of scheduled electronic transactions. For example, the transaction information may include a date range for the group event. Processor 102 may use the end time to determine whether the group event is over and whether to perform reconciliation.

At step 314, the system receives, over a second interface from a second user, transaction information associated with executed electronic transactions. For example, processor 102 may receive via interface 108 transaction information associated with executed electronic transactions (e.g., completed hotel stays (and related information such as dates, rates, etc.) from property network 12 and/or corporate network 14. The user may include a hotel employee or representative, or an automated management system such as a reservation or property management system.

At step 316, the system determines whether the end time for the group of scheduled electronic transactions has passed. For example, processor 102 may determine, based on an end time associated with the group event, that the group event is over (e.g., all electronic transactions associated with the event should be completed because the group event is over). If so, the method continues to step 318.

If the method determines that end time for the group of scheduled electronic transactions has not passed (e.g., the group event is not yet over), then the method returns to step 312 where it continues to receive information about electronic transactions from agency network 10, property network 12, and/or corporate network 14.

At step 318, the system compares the information associated with the executed electronic transactions with the information associated with the group of scheduled electronic transactions to determine a set of fulfilled electronic transactions. For example, processor 102 may compare the completed hotel stays with the group event registration information to determine which attendees actually completed a hotel stay. In some embodiments, processor 102 may perform the comparison soon after the group event has ended. In some embodiments, processor 102 may perform the comparison at a particular scheduled interval (e.g., weekly, monthly, quarterly, etc.).

At step 320, the system generates a request for payment fulfillment for the set of fulfilled electronic transactions. For example, processor 102 may generate a request for payment fulfillment associating completed stays with a particular group event. The request for payment fulfillment may include a commission amount associated with the group event. In some embodiments, processor 102 may generate additional reports, such as measurement and evaluation reports, or any other suitable reports.

At step 322, the system receives, from the second user, an approval of the request for payment fulfillment for the set of fulfilled electronic transactions. For example, processor 102 may receive via interface 108 approval to pay a commission associated with the group event.

At step 324, the system transfers funds from an account associated with the second user to an account associated with the first user. For example, processor 102 may transfer funds from an account at financial institution 102b associated with the hotel to an account a financial institution 102a associated with the meeting planner. In some embodiments, the system may pay the commission without waiting for approval in the previous step. Adjustments may be made at a later time if necessary.

Modifications, additions, or omissions may be made to the method of FIG. 3. Additionally, one or more steps in method 300 of FIG. 3 may be performed in parallel or in any suitable order.

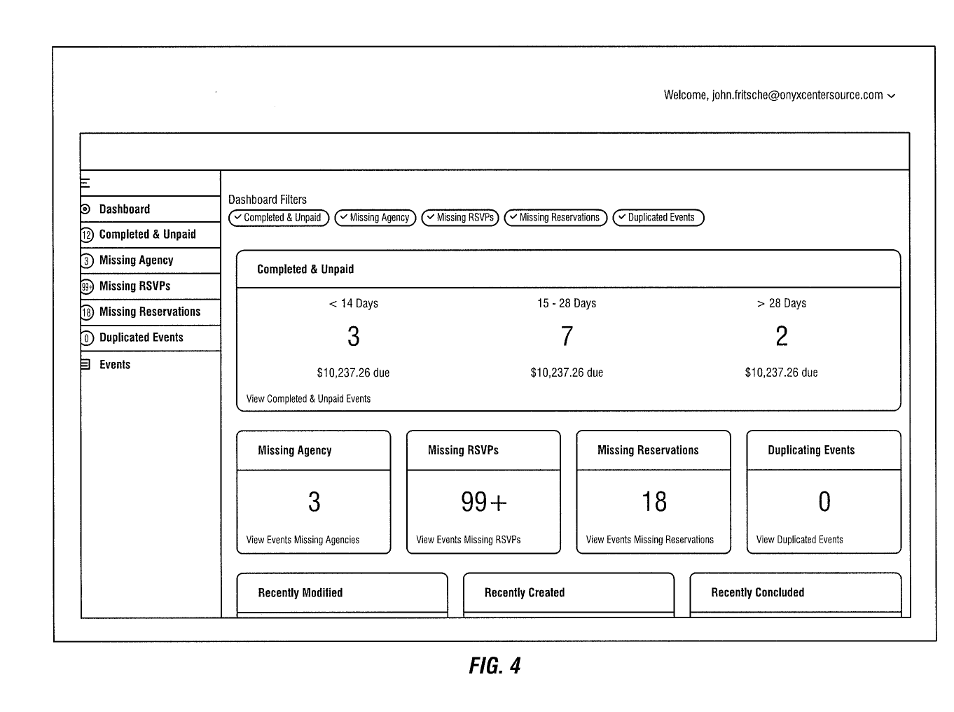

FIGS. 4-7 illustrate examples of graphical user interfaces, according to particular embodiments. Particular illustrations are provided as examples. Some embodiments may include more or less interfaces. Some embodiments may include different interfaces. Particular embodiments may include interfaces for searching for a group event, such as a web search tool based on keywords or other information associated with the event. Results may be displayed as a list of matching group events. Particular embodiments include filters for searching or browsing a list of group events.

FIG. 4 illustrates an example user interface for summarizing group event information. FIG. 4 illustrates a dashboard for summarizing particular information such as completed and unpaid items based on number of days and amounts outstanding, missing reservations, missing RSVPs, duplicate events, etc. Although illustrated as separate boxes, particular embodiments may combine or reorganize particular boxes, may include different time periods, may include additional information (e.g., incomplete events), etc.

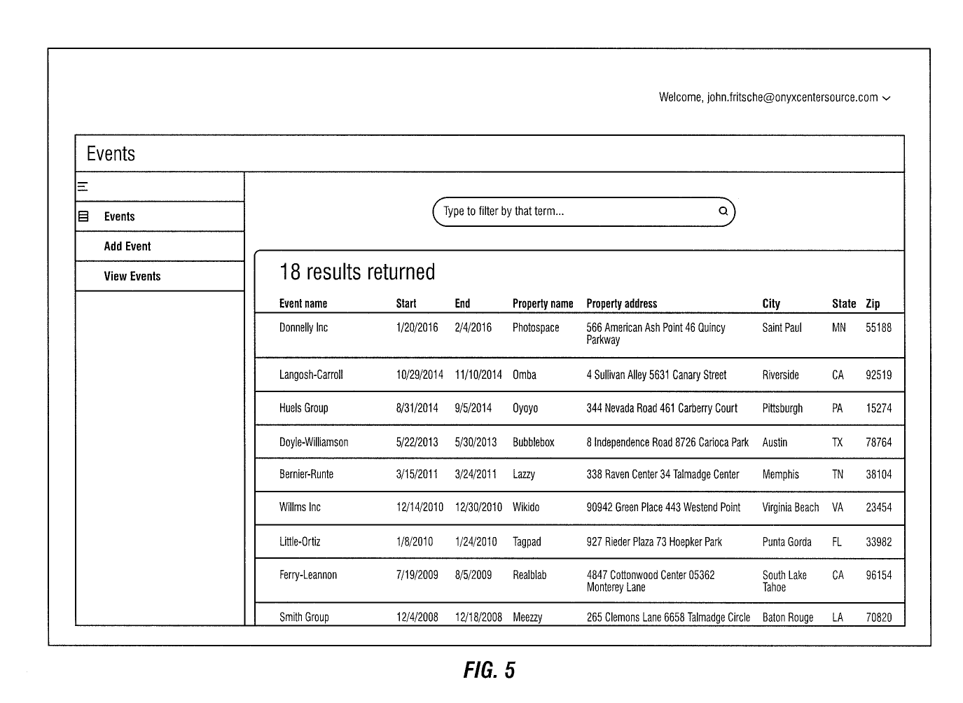

FIG. 5 illustrates an example user interface for locating group events. FIG. 5 illustrates a search box and a listing of group events that match the search criteria. A summary of each event is presented that includes the event name, start and end dates, and property information. Particular embodiments may include additional or different information in any suitable layout. Some embodiments may include the ability to browse all group events.

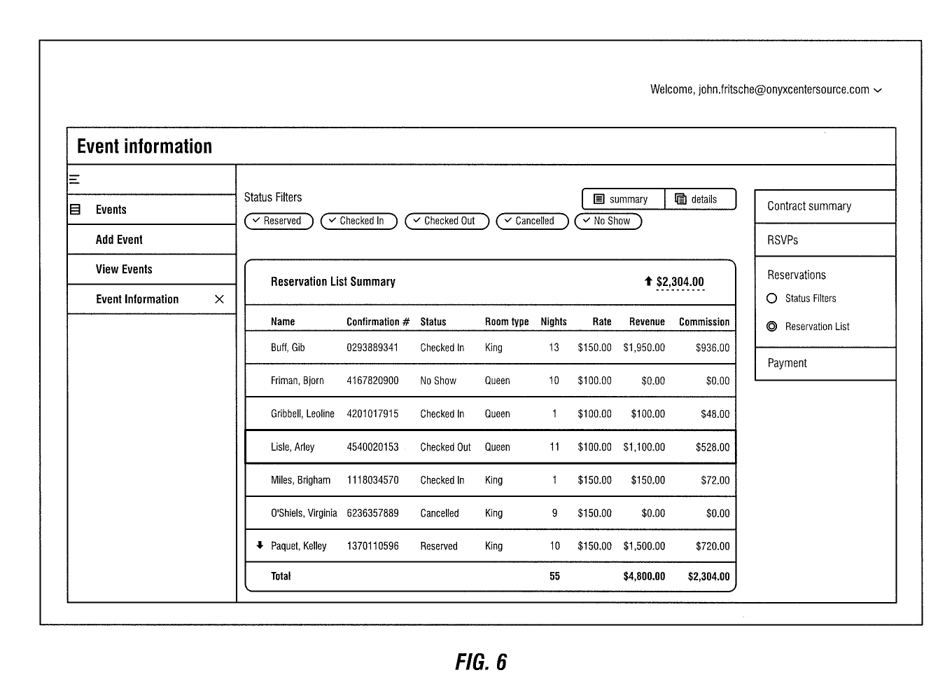

FIG. 6 illustrates an example user interface for viewing details of a particular group event. FIG. 6 illustrates a list of reservations associated with the group event. The reservation information includes attendee information (e.g., name) and hotel information (e.g., confirmation number, check-in status, type of room, number of nights, rate, etc.) and revenue information associated with the reservation (e.g., commission amount). Particular embodiments may include additional or different information in any suitable layout.

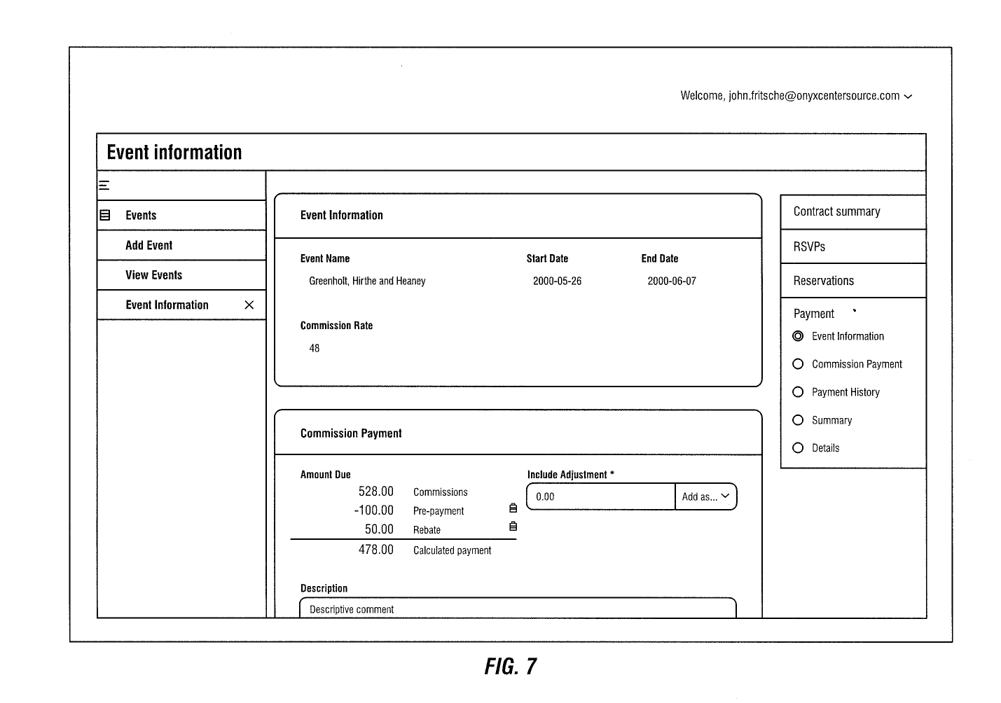

FIG. 7 illustrates another example user interface for viewing details of a particular group event. FIG. 7 illustrates the group event information such as event name, start and end dates, and contract information, such as commission rates, etc. Particular embodiments may include additional or different information in any suitable layout. Particular embodiments may include navigation controls to display a contract associated with the group event.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system for reconciling a group of electronic transactions, the system comprising:
a memory configured to store:
transaction information associated with a group of scheduled electronic transactions, wherein the transaction information includes an end time for the group of scheduled electronic transactions; and
transaction information associated with executed electronic transactions;
a first interface configured to receive, from a first user, information associated with the group of scheduled electronic transactions;
a second interface configured to receive, from a second user, information associated with the executed electronic transactions; and
a processor communicably coupled to the memory, the first interface, and the second interface, the processor configured to:
determine the end time for the group of scheduled electronic transactions has passed;
compare the information associated with the executed electronic transactions with the information associated with the group of scheduled electronic transactions to determine a set of fulfilled electronic transactions;
generate a request for payment fulfillment for the set of fulfilled electronic transactions;
the second interface further configured to receive, from the second user, an approval of the request for payment fulfillment for the set of fulfilled electronic transactions; and
the processor further configured to transfer funds from an account associated with the second user to an account associated with the first user.

2. The system of claim 1, wherein:
the first user comprises a travel agent or event planner user;
the second user comprises a hotel user;
the group of scheduled electronic transactions comprises a group hotel reservation;
the executed electronic transactions comprise completed hotel stay transactions; and
the generated request for payment fulfillment comprises a remittance notice for a commission payment to the first user for the set of fulfilled electronic transactions.

3. The system of claim 2, wherein the first interface comprises a bulk transfer interface with an event management system.

4. The system of claim 2, wherein the second interface comprises a bulk transfer interface with a hotel property management system.

5. The system of claim 2, wherein at least one of the first interface and the second interface is configured to receive contract information associated with the group of scheduled electronic transactions.

6. The system of claim 2, wherein the transaction information associated with the group of scheduled electronic transactions comprises:
an event name;
an event start date;
an event end date;
hotel property information;
travel agent or event planner information; and
a list of event attendees.

7. The system of claim 1, wherein the processor is further configured to translate the received information associated with the group of scheduled electronic transactions into an internal format.

8. The system of claim 1, wherein the processor is further configured to translate the received information associated with the executed electronic transactions into an internal format.

9. The system of claim 1, wherein the first interface is further configured to receive account information for receiving the transfer of funds.

10. The system of claim 1, wherein the second interface is further configured to receive account information for sending the transfer of funds.

11. A method of reconciling a group of electronic transactions, the method comprising:
receiving, over a first interface from a first user, transaction information associated with a group of scheduled electronic transactions, wherein the transaction information includes an end time for the group of scheduled electronic transactions;
receiving, over a second interface from a second user, transaction information associated with executed electronic transactions;
determining the end time for the group of scheduled electronic transactions has passed;
comparing the information associated with the executed electronic transactions with the information associated with the group of scheduled electronic transactions to determine a set of fulfilled electronic transactions;
generating a request for payment fulfillment for the set of fulfilled electronic transactions;
receiving, from the second user, an approval of the request for payment fulfillment for the set of fulfilled electronic transactions; and
transferring funds from an account associated with the second user to an account associated with the first user.

12. The method of claim 11, wherein:
the first user comprises a travel agent or event planner user;
the second user comprises a hotel user;
the group of scheduled electronic transactions comprises a group hotel reservation;
the executed electronic transactions comprise completed hotel stay transactions; and
the generated request for payment fulfillment comprises a remittance notice for a commission payment to the first user for the set of fulfilled electronic transactions.

13. The method of claim 12, wherein the first interface comprises a bulk transfer interface with an event management system.

14. The method of claim 12, wherein the second interface comprises a bulk transfer interface with a hotel property management system.

15. The method of claim 12, further comprising, receiving, on at least one of the first interface and the second interface, contract information associated with the group of scheduled electronic transactions.

16. The method of claim 12, wherein the transaction information associated with the group of scheduled electronic transactions comprises:
an event name;
an event start date;
an event end date;
hotel property information;
travel agent or event planner information; and
a list of event attendees.

17. The method of claim 11, further comprising translating the received information associated with the group of scheduled electronic transactions into an internal format.

18. The method of claim 11, further comprising translating the received information associated with the executed electronic transactions into an internal format.

19. The method of claim 11, further comprising receiving, on the first interface, account information for receiving the transfer of funds.

20. The method of claim 11, further comprising receiving, on the second interface, account information for sending the transfer of funds.
